(19) United States
(12) Patent Application Publication
(10) Pub. No.: US 2024/0319719 A1
(43) Pub. Date: Sep. 26, 2024

(54) SYSTEMS, METHODS, AND COMPUTER PROGRAM PRODUCTS FOR PRODUCTION AND QUALITY TRACKING

(71) Applicant: Honeywell International Inc., Charlotte, NC (US)

(72) Inventors: Sunil Golani, Bangalore (IN); Murali D, Bangalore (IN); LingaThurai Palanisamy, Bangalore (IN); Niranjan Amrutur Subba Rao, Bangalore (IN)

(21) Appl. No.: 18/591,393

(22) Filed: Feb. 29, 2024

(30) Foreign Application Priority Data
Mar. 21, 2023 (IN) 202311019367

(51) Int. Cl. G05B 19/418; G06F 3/04842; G06F 3/0486

(52) U.S. Cl. CPC G05B 19/41875; G06F 3/04842; G06F 3/0486

(57) ABSTRACT

Methods, apparatuses, and computer program products for production tracking are provided. For example, a computer-implemented method may include receiving user selections corresponding to (i) equipment stations of a production line, (ii) links from each equipment station to preceding and/or succeeding equipment stations, and (iii) data to be captured each time a turnup event indicating completion of a production unit occurs; creating a graphic representation of the production line; each time a turnup event occurs at one of the equipment stations, determining (i) any immediately preceding equipment stations, (ii) a turnup start time, and (iii) one or more parent production units created by the immediately preceding equipment station immediately prior to the turnup event; obtaining quality status information for each production unit in a parent/child sequence; and displaying the graphic representation of the production line with the quality status information for each of the production units.

### CROSS-REFERENCE TO RELATED APPLICATIONS

This application claims priority to and the benefit of foreign India Patent Application Serial No., 202311019367, filed on Mar. 21, 2023, and entitled “SYSTEMS AND METHODS FOR BATTERY MANUFACTURING QUALITY,” which is incorporated herein by reference in its entirety.

### TECHNOLOGICAL FIELD

Example embodiments of the present disclosure relate generally to production control and, more particularly, to tracking quality issues in a production line.

### BACKGROUND

Lithium-ion battery (LIB) manufacturing is a large-scale automated process with a strict focus on quality. Battery manufacturers, especially manufacturers of lithium-ion batteries, are under pressure to make sure the batteries they produce are compliant with quality standards and are traceable to the process and the raw materials that were consumed, to avoid scrap rates and product recalls.

However, Applicant has discovered many technological inefficiencies related to traditional production control techniques.

### BRIEF SUMMARY

The details of some embodiments of the subject matter described in this specification are set forth in the accompanying drawings and the description below. Other features, aspects, and advantages of the subject matter will become apparent from the description, the drawings, and the claims.

In accordance with a first aspect of the disclosure, a computer-implemented method for production tracking is provided. In at least one example embodiment, an example method comprises receiving a plurality of user selections corresponding to (i) a plurality of equipment stations of a production line, (ii) links from each equipment station to one or more preceding equipment stations and/or one or more succeeding equipment stations, and (iii) data to be captured each time a turnup event indicating completion of a production unit occurs at each of one or more of the equipment stations; creating a graphic representation of the production line corresponding to the plurality of user selections; storing data corresponding to the graphic representation in one or more servers or one or more cloud computing devices; each time a turnup event occurs at one of the plurality of equipment stations, determining (i) any immediately preceding equipment stations to the one of the equipment station at which the turnup event occurred, (ii) a turnup start time, and (iii) one or more parent production units created by the immediately preceding equipment station immediately prior to the turnup event; obtaining quality status information for each of a plurality of production units in a parent/child sequence; and displaying the graphic representation of the production line with the quality status information for each of the plurality of production units in the parent/child sequence.

In some embodiments, the turnup start time is determined based on a turnup end time and a predetermined process time.

In some embodiments, the example method comprises identifying one or more root causes of an unacceptable quality status of a production unit based on an unacceptable quality status of a prior different production unit in the parent/child sequence.

In some embodiments, the example method comprises, each time a turnup event occurs, identifying or creating a unique identifier for the completed production unit.

In some embodiments, the data to be captured each time a turnup event occurs includes a station identifier, a unique identifier for the completed production unit, and one or more production parameters.

In some embodiments, the one or more production parameters include width, length, weight, speed, diameter, and a turnup end time.

In some embodiments, the user selections of equipment stations and links are dragged and dropped from a predetermined toolbox of selections.

In accordance with another aspect of the disclosure, an apparatus for production tracking is provided. The apparatus comprises at least one processor and at least one non-transitory memory comprising program code. The at least one non-transitory memory and the program code are configured to, with the at least one processor, cause the apparatus to receive a plurality of user selections corresponding to (i) a plurality of equipment stations of a production line, (ii) links from each equipment station to one or more preceding equipment stations and/or one or more succeeding equipment stations, and (iii) data to be captured each time a turnup event indicating completion of a production unit occurs at each of one or more of the equipment stations; create a graphic representation of the production line corresponding to the plurality of user selections; store data corresponding to the graphic representation in one or more servers or one or more cloud computing devices; each time a turnup event occurs at one of the plurality of equipment stations, determine (i) any immediately preceding equipment stations to the one of the equipment station at which the turnup event occurred, (ii) a turnup start time, and (iii) one or more parent production units created by the immediately preceding equipment station immediately prior to the turnup event; obtain quality status information for each of a plurality of production units in a parent/child sequence; and display the graphic representation of the production line with the quality status information for each of the plurality of production units in the parent/child sequence.

In accordance with yet another aspect of the disclosure, an example computer program product is provided. The example computer program product includes at least one non-transitory computer-readable storage medium having computer-readable program code portions stored therein, the computer-readable program code portions comprising an executable portion configured to at least receive a plurality of user selections corresponding to (i) a plurality of equipment stations of a production line, (ii) links from each equipment station to one or more preceding equipment stations and/or one or more succeeding equipment stations, and (iii) data to be captured each time a turnup event indicating completion of a production unit occurs at each of one or more of the equipment stations; create a graphic representation of the production line corresponding to the plurality of user selections; store data corresponding to the graphic representation in one or more servers or one or more cloud computing devices; each time a turnup event occurs at one of the plurality of equipment stations, determine (i) any immediately preceding equipment stations to the one of the equipment station at which the turnup event occurred, (ii) a turnup start time, and (iii) one or more parent production units created by the immediately preceding equipment station immediately prior to the turnup event; obtain quality status information for each of a plurality of production units in a parent/child sequence; and display the graphic representation of the production line with the quality status information for each of the plurality of production units in the parent/child sequence.

### BRIEF DESCRIPTION OF THE DRAWINGS

Having thus described the embodiments of the disclosure in general terms, reference now will be made to the accompanying drawings, which are not necessarily drawn to scale, and wherein:

FIG. 1 illustrates a block diagram of an example system within which embodiments of the present disclosure may operate, in accordance with some embodiments of the present disclosure;

FIG. 2 illustrates a block diagram of an example apparatus that may be specially configured in accordance with an example embodiment of the present disclosure;

FIG. 3 illustrates a flow chart for production tracking, in accordance with an example embodiment of the present disclosure; and

FIGS. 4A and 4B illustrate an example graphical representation of a production line, in accordance with some embodiments of the present disclosure.

### DETAILED DESCRIPTION OF THE INVENTION

Some embodiments of the present disclosure will now be described more fully hereinafter with reference to the accompanying drawings, in which some, but not all embodiments of the disclosure are shown. Indeed, these disclosures may be embodied in many different forms and should not be construed as limited to the embodiments set forth herein; rather, these embodiments are provided so that this disclosure will satisfy applicable legal requirements. Like numbers refer to like elements throughout.

Lithium-ion battery manufacturing generally involves manufacturing of individual cells. Varying numbers of such cells are packed together to form a battery pack. Depending on the form factor and the number of cells, among other features, these battery packs may be used with mobile phones, laptop computers, electric vehicles, or many other types of battery-powered devices.

Lithium-ion battery cells comprise three layers-two electrodes (an anode and a cathode) with a separator between the two electrodes. The electrodes comprise sheets constructed from long aluminum and copper coils. For example, such coils may be six kilometers long. The coils are unrolled and one or more coatings of a slurry of chemicals are applied. Some areas are left uncoated to enable electrical connections. The coatings are typically applied in lanes, with uncoated areas between the lanes of coatings. For example, the coatings may be applied in three or six lanes, or any suitable number of lanes.

After the chemical coatings are applied to the unrolled coils and dried, the rolls are split into smaller rolls and the smaller rolls are cut into sheets. The cut sheets are rolled into what are commonly termed “jelly rolls,” which are inserted into hollow cylinder casings to form the cells.

In accordance with various embodiments of the present disclosure, a Quality Management System (QMS) is connected with a Manufacturing Execution System (MES) for overseeing battery production and delivering real-time operational data for consolidation into financial metrics, such as in an Enterprise Resource Planning (ERP) system. In some embodiments, such a system allows QMS to connect with MES data to assesses quality in all forms at every step of the production process. This provides a real-time view of the plant's quality position, which in turn connects with and improves ERP financial projections (to be discussed below).

In some embodiments, such a connected QMS includes quality management (QM) tools enhanced with artificial intelligence (AI) and machine learning (ML) for root cause analysis. In some embodiments, such a connected QMS provides integrated modules that work together to support quality, compliance, and more effective decision making with reporting and advanced analytics. In some embodiments, such a connected QMS brings together critical quality events and processes such as deviations, change controls, procedure changes, and approvals—as well as training and validations that occur in the production process.

Some embodiments of the present disclosure enable determining product quality at each step of LIB production and predicting the quality of child rolls and subsequent batches of final LIB cells. Some embodiments of the present disclosure enable automatic disposition of units based on quality and signal a need to change subsequent production plan. Some embodiments of the present disclosure enable integrated quality checks at multiple production stages and the ability to predict quality issues in successive production steps.

Some embodiments of the present disclosure enable tracking of production across multiple plants and various steps of production therein. Some embodiments of the present disclosure enable automated production tracking with integrated quality control and intuitive capabilities to bring out anomalies and their impact on the subsequent production steps.

Some embodiments of the present disclosure enable identification of root cause of anomalies to detect failures.

In a production line, such as a LIB production line, there are multiple stages of equipment through which raw materials, work in process (WIP), inventory, etc., pass until a final unit cell is produced. If a defect occurs at one stage, that defect might propagate along the process and create problems in the subsequent stages. As such, it is preferable to identify and remove or remedy that defect right away. However, it is possible that such a defect is not detected. Additionally, it is possible that a minor issue occurs that does not qualify as a defect and is allowed to pass through. If another issue occurs at a later stage, the combination of the two minor issues may cause a more significant problem but might not be detected.

In other situations, defects may not be immediately identifiable. For example, a production run may occur in which a raw material is used that is later identified to be defective. In such situations, it is desirable to be able to later identify the products that that were produced using the defective raw material.

For example, consider a situation in which a batch of slurry is later determined to have been defective after being used to coat one or more rolls. It would be desirable to determine, for example, how many rolls were coated with the defective slurry, how many unit cells were produced using those rolls and to identify, for example, the “parent roll” (i.e., the original, uncut roll), the “child rolls” (i.e., the smaller rolls into which the parent roll is cut), and the unit cells associated with that batch ID of the slurry. This could be particularly useful and important information if the unit cells produced using that defective raw material were shipped out and incorporated into batteries that were in turn shipped out to manufacturers and/or consumers.

As another example, consider a situation in which multiple battery fires occur. As part of understanding why such fires occurred and preventing future fires, it may be desirable to track the manufacturing process of the unit cells used in the batteries. For example, it may be helpful to determine what raw materials were used but also to determine some or all of the manufacturing parameters (e.g., temperatures, machine settings, etc.) that were used during manufacturing. Knowing this information can help identify raw materials and/or manufacturing processes/parameters/etc. that may have caused or be causing defective products. This enables the identification of other already produced products that may have the same defect, which can facilitate recalls if needed. This also enables the identification of manufacturing processes/parameters/etc. that may have caused and/or are causing defects so they may be corrected to prevent future defective products.

In some embodiments, a traceability is provided of the history of how a particular unit cell was manufactured, end to end, by capturing, for example, the manufacturing records such as the process steps/settings/parameters/etc., which child roll the unit cell was made from, which parent roll did the child roll come from, which batch of raw material was used, who was the vendor for each raw material, etc. Tracking the raw materials, vendors, machine parameters, and other manufacturing details along the entire manufacturing process may be termed “genealogy.”

In this regard, a product being produced on a production line may go through various steps at each of a plurality of equipment stations. Each equipment station typically produces a production unit which is then passed on to the next equipment station at which further processes are performed on and/or further materials (e.g., raw materials, sub-components, etc.) are added to the production unit from the preceding station, resulting in another production unit (i.e., a further processed version of the preceding production unit). The term production unit may also, in various embodiments, refer to a raw material or combination of raw materials provided by an equipment station. For example, at the beginning of a production line for LIB cells, one equipment station unwinds a long, continuous coil of metal (which may be termed a master coil) and feeds the coil to a coating machine. At the same time, another equipment station pumps a slurry (electrode or cathode materials dispersed in an organic solvent) to the same coating machine which applies the slurry to one side of the unwound coil. While the metal coil and the slurry may be considered raw materials, the metal coil and slurry may also be considered production units. In this example, the coating machine combines the production units (uncoated coil and slurry) from two prior equipment stations to create a new production unit (i.e., the coated coil). In various embodiments, two or more parent production units from one equipment station may immediately precede another, single production unit. For example, it is possible that multiple slurry batches are used to produce a single coater production unit. In such cases, those multiple slurry loads would be considered parent production units of a single coated sheet.

The last equipment station in the production line produces what may be termed a final production unit, which may be a final product or which may be WIP that is, for example, further processed on a different production line or combined with one or more other WIP units to produce a final product. When considering the production of a single final production unit, the production units that are passed from equipment station to equipment station and the final production unit (which are essentially a single production unit that has undergone processing at each equipment station) may together be termed a parent/child sequence or a genealogy. When an equipment station completes a production unit, this is often termed a turnup event or simply turnup. When a turnup event occurs, the equipment station typically sends a signal indicating so.

Various embodiments of the present disclosure relate to systems and methods for tracking production to monitor battery manufacturing quality, such as for lithium-ion batteries. In various embodiments, a graphical representation of a factory production line is created from user inputs. In various embodiments, such a production line comprises a plurality of equipment stations, such as, in a LIB manufacturing facility for example, coating machines, dryers, calendering machines, slitters, etc. In various embodiments, the user inputs include user selections of equipment stations and links between pairs of equipment stations. In various embodiments, such user selections are dragged and dropped from a toolbox of predetermined equipment stations.

In various embodiments, user inputs also define data to be captured each time a turnup event occurs at each of the equipment stations. In some embodiments, such dat includes but is not limited to an equipment station identifier, a unique identifier for the completed production unit (if one is provided by the equipment station), one or more production parameters (e.g., width, length, weight, speed, diameter, etc.), and/or a turnup end time (i.e., when did the process occurring at the equipment station complete). If the equipment station does not provide a unique identifier for the completed production unit, various embodiments of the present disclosure will create such a unique identifier.

Each time a turnup event occurs at one of the equipment stations, various embodiments of the present disclosure will determine the one or more (if any) immediately preceding equipment stations to the equipment station at which the turnup event occurred. This determination is based on the user input described above of the links between the equipment stations.

Each time a turnup event occurs at one of the equipment stations, various embodiments of the present disclosure will also determine a turnup start time (i.e., when did the process occurring at the equipment station begin). In various embodiments, the turnup start time is calculated based on the turnup end time and a predetermined process time. That is, by knowing when the production process ended and how long the production process takes, the turnup start time can be calculated.

Each time a turnup event occurs at one of the equipment stations, various embodiments of the present disclosure will also determine the parent production unit (i.e., the production unit that was created by the immediately preceding equipment station and provided to the equipment station issuing the turnup signal for further processing). In various embodiments this determination is made by comparing the turnup start time to the most recent turnup end time of the immediately preceding equipment station and identifying the production unit created by the immediately preceding equipment station whose turnup end time is prior to and closest in time to the turnup start time of the equipment station in question.

In various embodiments, quality status information is obtained for each of the production units in a parent/child sequence. Such quality status information may be obtained from a variety of different sources, including but not limited to nuclear scanners, imaging systems, laboratory reports, etc. In various embodiments, such quality status information is displayed on the graphic representation of the production line for each of the plurality of production units in the parent/child sequence.

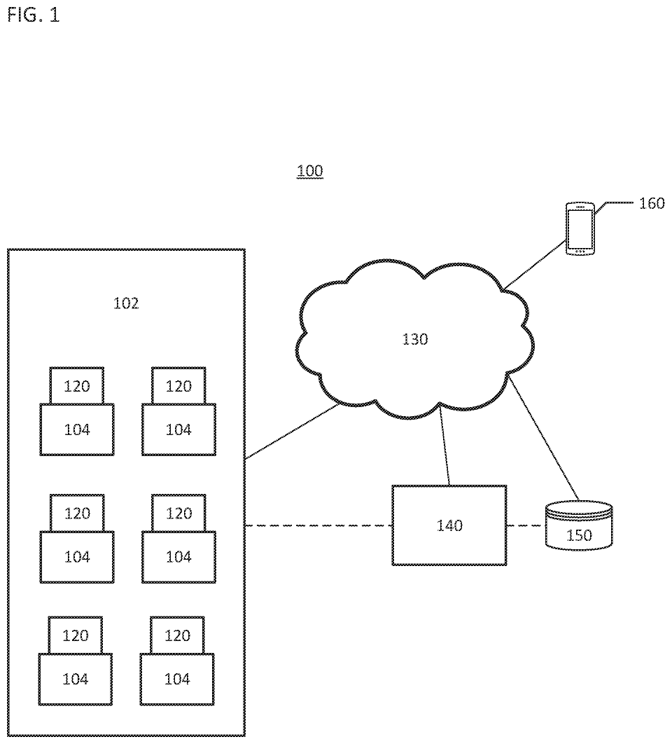

Referring now to FIG. 1, an exemplary block diagram of an environment 100 in which embodiments of the present disclosure may operate is illustrated. Specifically, FIG. 1 illustrates a plant 102 comprising a number of different production processes 104 that each perform different tasks for producing a final product (e.g., a blended, constructed, or otherwise combined product) from one or more input ingredients. For example, the plant 102 may manufacture lithium-ion batteries and the production processes 104 may include one or more coating processes, one or more drying processes, one or more slitting processes, etc. In some embodiments, some or all of the production process may include and/or interface with one or more monitoring devices 120 for observing, measuring, analyzing, and/or the like various parameters/results/etc. related to the corresponding production processes 104. For example, in some embodiments, monitoring devices 120 may record production parameters, such as a time-stamped temperature reading, during a production process. As another example, in some embodiments, monitoring devices may scan for defects and record and report any such defects.

A monitoring device 120 may generate and/or transmit data across a network 130 to an operations processing system 140. The operations processing system 140 may be electronically and/or communicatively coupled to one or more plant(s), for example to plant 102, one or more databases 150, and one or more user devices 160.

The network 130 may be embodied in any of a myriad of network configurations. In some embodiments, the network 130 may be a public network (e.g., the Internet). In some embodiments, the network 130 may be a private network (e.g., an internal localized, or closed-off network between particular devices). In some other embodiments, the network 130 may be a hybrid network (e.g., a network enabling internal communications between particular connected devices and external communications with other devices). In various embodiments, the network 130 may include one or more base station(s), relay(s), router(s), switch(es), cell tower(s), communications cable(s), routing station(s), and/or the like. In various embodiments, components of the environment 100 may be communicatively coupled to transmit data to and/or receive data from one another over the network 130. Such configuration(s) include, without limitation, a wired or wireless Personal Area Network (PAN), Local Area Network (LAN), Metropolitan Area Network (MAN), Wide Area Network (WAN), and/or the like.

The operations processing system 140 may be located remotely or in proximity of a particular plant, for example the plant 102. In some embodiments, the operations processing system 140 is configured via hardware, software, firmware, and/or a combination thereof, to perform data intake of one or more types of data associated with one or more plant(s), for example the plant 102. Additionally or alternatively, in some embodiments, the operations processing system 140 is configured via hardware, software, firmware, and/or a combination thereof, to generate and/or transmit command(s) that control, adjust, or otherwise impact operations of a particular plant or specific component(s) thereof, for example for controlling one or more operations of the plant 102. Additionally or alternatively still, in some embodiments, the operations processing system 140 is configured via hardware, software, firmware, and/or a combination thereof, to perform data reporting and/or other data output process(es) associated with monitoring or otherwise analyzing operations of one or more processing plant(s), for example for generating and/or outputting report(s) corresponding to the operations performed via the plant 102. For example, in various embodiments, the operations processing system 140 may be configured to execute and/or perform one or more operations and/or functions described herein.

The one or more databases 150 may be configured to receive, store, and/or transmit data. In various embodiments, the one or more databases may be associated with production data received from monitoring devices 120. The production data may include historical production data as well as current and/or real-time production data. Additionally or alternatively, in some embodiments the one or more databases 150 store user inputted data associated with operations of one or more plant(s). In some embodiments, the one or more databases 150 store data associated with multiple individual plant(s), for example multiple plants associated with the same enterprise entity but located in different geographic locations across the world.

The one or more user devices 160 may be associated with users of the operations processing system 140. In various embodiments, the operations processing system 140 may generate and/or transmit a message, alert, or indication to a user via a user device 160. Additionally, or alternatively, a user device 160 may be utilized by a user to remotely access an operations processing system 140. This may be by, for example, an application operating on the user device 160. A user may access the operations processing system 140 remotely, including one or more visualizations, reports, and/or real-time displays.

Additionally, while FIG. 1 illustrates certain components as separate, standalone entities communicating over the network 130, various embodiments are not limited to this configuration. In other embodiments, one or more components may be directly connected and/or share hardware or the like. For example, in some embodiments, the operations processing system 140 may include one or more databases 150, which may collectively be located in or at the plant 102.

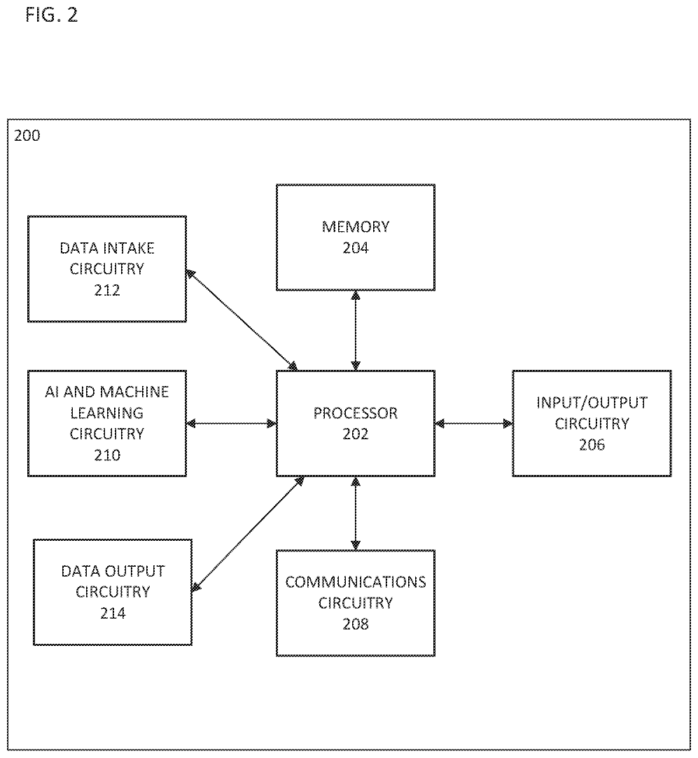

Referring now to FIG. 2, an exemplary block diagram of an example apparatus that may be specially configured in accordance with an example embodiment of the present disclosure is illustrated. Specifically, FIG. 2 depicts an example computing apparatus 200 (“apparatus 200”) specially configured in accordance with at least some example embodiments of the present disclosure. Examples of an apparatus 200 may include, but is not limited to, a monitoring device 120, an operations processing system 140, a database 150, and/or a user device 160. The apparatus 200 includes processor 202, memory 204, input/output circuitry 206, communications circuitry 208, artificial intelligence (“AI”) and machine learning (“ML”) circuitry 210, data intake circuitry 212, and data output circuitry 214. In some embodiments, the apparatus 200 is configured to execute and perform the operations described herein.

Although components are described with respect to functional limitations, it should be understood that the particular implementations necessarily include the use of particular computing hardware. It should also be understood that in some embodiments certain of the components described herein include similar or common hardware. For example, in some embodiments two sets of circuitry both leverage use of the same processor(s), memory(ies), circuitry(ies), and/or the like to perform their associated functions such that duplicate hardware is not required for each set of circuitry.

In various embodiments, such as a computing apparatus 200 of an operations processing system 140 or of a user device 160 may refer to, for example, one or more computers, computing entities, desktop computers, mobile phones, tablets, phablets, notebooks, laptops, distributed systems, servers, or the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein. In one embodiment, these functions, operations, and/or processes can be performed on data, content, information, and/or similar terms used herein. In this regard, the apparatus 200 embodies a particular, specially configured computing entity transformed to enable the specific operations described herein and provide the specific advantages associated therewith, as described herein.

Processor or processing circuitry 202 may be embodied in a number of different ways. In various embodiments, the use of the terms “processor” should be understood to include a single core processor, a multi-core processor, multiple processors internal to the apparatus 200, and/or one or more remote or “cloud” processor(s) external to the apparatus 200. In some example embodiments, processor 202 may include one or more processing devices configured to perform independently. Alternatively, or additionally, processor 202 may include one or more processor(s) configured in tandem via a bus to enable independent execution of operations, instructions, pipelining, and/or multithreading.

In an example embodiment, the processor 202 may be configured to execute instructions stored in the memory 204 or otherwise accessible to the processor. Alternatively, or additionally, the processor 202 may be configured to execute hard-coded functionality. As such, whether configured by hardware or software methods, or by a combination thereof, processor 202 may represent an entity (e.g., physically embodied in circuitry) capable of performing operations according to embodiments of the present disclosure while configured accordingly. Alternatively, or additionally, processor 202 may be embodied as an executor of software instructions, and the instructions may specifically configure the processor 202 to perform the various algorithms embodied in one or more operations described herein when such instructions are executed. In some embodiments, the processor 202 includes hardware, software, firmware, and/or a combination thereof that performs one or more operations described herein.

In some embodiments, the processor 202 (and/or co-processor or any other processing circuitry assisting or otherwise associated with the processor) is/are in communication with the memory 204 via a bus for passing information among components of the apparatus 200.

Memory or memory circuitry 204 may be non-transitory and may include, for example, one or more volatile and/or non-volatile memories. In some embodiments, the memory 204 includes or embodies an electronic storage device (e.g., a computer readable storage medium). In some embodiments, the memory 204 is configured to store information, data, content, applications, instructions, or the like, for enabling an apparatus 200 to carry out various operations and/or functions in accordance with example embodiments of the present disclosure.

Input/output circuitry 206 may be included in the apparatus 200. In some embodiments, input/output circuitry 206 may provide output to the user and/or receive input from a user. The input/output circuitry 206 may be in communication with the processor 202 to provide such functionality. The input/output circuitry 206 may comprise one or more user interface(s). In some embodiments, a user interface may include a display that comprises the interface(s) rendered as a web user interface, an application user interface, a user device, a backend system, or the like. In some embodiments, the input/output circuitry 206 also includes a keyboard, a mouse, a joystick, a touch screen, touch areas, soft keys a microphone, a speaker, or other input/output mechanisms. The processor 202 and/or input/output circuitry 206 comprising the processor may be configured to control one or more operations and/or functions of one or more user interface elements through computer program instructions (e.g., software and/or firmware) stored on a memory accessible to the processor (e.g., memory 204, and/or the like). In some embodiments, the input/output circuitry 206 includes or utilizes a user-facing application to provide input/output functionality to a computing device and/or other display associated with a user.

Communications circuitry 208 may be included in the apparatus 200. The communications circuitry 208 may include any means such as a device or circuitry embodied in either hardware or a combination of hardware and software that is configured to receive and/or transmit data from/to a network and/or any other device, circuitry, or module in communication with the apparatus 200. In some embodiments the communications circuitry 208 includes, for example, a network interface for enabling communications with a wired or wireless communications network. Additionally or alternatively, the communications circuitry 208 may include one or more network interface card(s), antenna(s), bus(es), switch(es), router(s), modem(s), and supporting hardware, firmware, and/or software, or any other device suitable for enabling communications via one or more communications network(s). In some embodiments, the communications circuitry 208 may include circuitry for interacting with an antenna(s) and/or other hardware or software to cause transmission of signals via the antenna(s) and/or to handle receipt of signals received via the antenna(s). In some embodiments, the communications circuitry 208 enables transmission to and/or receipt of data from a user device, one or more monitoring devices, and/or other external computing device(s) in communication with the apparatus 200.

AI and machine learning circuitry 210 may be included in the apparatus 200. The AI and machine learning circuitry 210 may include hardware, software, firmware, and/or a combination thereof designed and/or configured to request, receive, process, generate, and transmit data, data structures, control signals, and electronic information for training and executing a trained AI and machine learning model configured to facilitating the operations and/or functionalities described herein. For example, in some embodiments the AI and machine learning circuitry 210 includes hardware, software, firmware, and/or a combination thereof, that identifies training data and/or utilizes such training data for training a particular machine learning model, AI, and/or other model to generate particular output data based at least in part on learnings from the training data. Additionally or alternatively, in some embodiments, the AI and machine learning circuitry 210 includes hardware, software, firmware, and/or a combination thereof, that embodies or retrieves a trained machine learning model, AI and/or other specially configured model utilized to process inputted data. Additionally or alternatively, in some embodiments, the AI and machine learning circuitry 210 includes hardware, software, firmware, and/or a combination thereof that processes received data utilizing one or more algorithm(s), function(s), subroutine(s), and/or the like, in one or more pre-processing and/or subsequent operations that need not utilize a machine learning or AI model.

Data intake circuitry 212 may be included in the apparatus 200. The data intake circuitry 212 may include hardware, software, firmware, and/or a combination thereof, designed and/or configured to capture, receive, request, and/or otherwise gather data associated with operations of one or more plant(s). In some embodiments, the data intake circuitry 212 includes hardware, software, firmware, and/or a combination thereof, that communicates with one or more sensor(s). unit(s), and/or the like within a particular plant to receive particular data associated with such operations of the plant. The data intake circuitry 212 may support such operations for any number of individual plants. Additionally or alternatively, in some embodiments, the data intake circuitry 212 includes hardware, software, firmware, and/or a combination thereof, that retrieves particular data associated with one mor more plant(s) from one or more data repository/repositories accessible to the apparatus 200.

Data output circuitry 214 may be included in the apparatus 200. The data output circuitry 214 may include hardware, software, firmware, and/or a combination thereof, that configures and/or generates an output based at least in part on data processed by the apparatus 200. In some embodiments, the data output circuitry 214 includes hardware, software, firmware, and/or a combination thereof, that generates a particular report based at least in part on the processed data, for example where the report is generated based at least in part on a particular reporting protocol. Additionally or alternatively, in some embodiments, the data output circuitry 214 includes hardware, software, firmware, and/or a combination thereof, that configures a particular output data object, output data file, and/or user interface for storing, transmitting, and/or displaying. For example, in some embodiments, the data output circuitry 214 generates and/or specially configures a particular data output for transmission to another system sub-system for further processing. Additionally or alternatively, in some embodiments, the data output circuitry 214 includes hardware, software, firmware, and/or a combination thereof, that causes rendering of a specially configured user interface based at least in part on data received by and/or processing by the apparatus 200.

In some embodiments, two or more of the sets of circuitries 202-214 are combinable. Alternatively, or additionally, one or more of the sets of circuitry 202-214 perform some or all of the operations and/or functionality described herein as being associated with another circuitry. In some embodiments, two or more of the sets of circuitry 202-214 are combined into a single module embodied in hardware, software, firmware, and/or a combination thereof. For example, in some embodiments, one or more of the sets of circuitry, for example the AI and machine learning circuitry 210, may be combined with the processor 202, such that the processor 202 performs one or more of the operations described herein with respect the AI and machine learning circuitry 210.

It is to be understood that the disclosure is not to be limited to the specific embodiments disclosed, and that modifications and other embodiments are intended to be included within the scope of the appended claims. Although specific terms are employed herein, they are used in a generic and descriptive sense only and not for purposes of limitation, unless described otherwise.

Although an example processing system has been described above, implementations of the subject matter and the functional operations described herein can be implemented in other types of digital electronic circuitry, or in computer software, firmware, or hardware, including the structures disclosed in this specification and their structural equivalents, or in combinations of one or more of them.

Embodiments of the subject matter and the operations described herein can be implemented in digital electronic circuitry, or in computer software, firmware, or hardware, including the structures disclosed in this specification and their structural equivalents, or in combinations of one or more of them. Embodiments of the subject matter described herein can be implemented as one or more computer programs, i.e., one or more modules of computer program instructions, encoded on computer storage medium for execution by, or to control the operation of, information/data processing apparatus. Alternatively, or in addition, the program instructions can be encoded on an artificially-generated propagated signal, e.g., a machine-generated electrical, optical, or electromagnetic signal, which is generated to encode information/data for transmission to suitable receiver apparatus for execution by an information/data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described herein can be implemented as operations performed by an information/data processing apparatus on information/data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a repository management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or information/data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described herein can be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read-only memory or a random access memory or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, e.g., magnetic, magneto-optical disks, or optical disks. However, a computer need not have such devices. Devices suitable for storing computer program instructions and information/data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described herein can be implemented on a computer having a display device, e.g., a CRT (cathode ray tube) or LCD (liquid crystal display) monitor, for displaying information/data to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described herein can be implemented in a computing system that includes a back-end component, e.g., as an information/data server, or that includes a middleware component, e.g., an application server, or that includes a front-end component, e.g., a client computer having a graphical user interface or a web browser through which a user can interact with an implementation of the subject matter described herein, or any combination of one or more such back-end, middleware, or front-end components. The components of the system can be interconnected by any form or medium of digital information/data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits information/data (e.g., an HTML page) to a client device (e.g., for purposes of displaying information/data to and receiving user input from a user interacting with the client device). Information/data generated at the client device (e.g., a result of the user interaction) can be received from the client device at the server.

While this specification contains many specific implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

Having described example systems and apparatuses in accordance with the present disclosure, example processes for production tracking will now be discussed. It will be appreciated that each of the flowcharts depicts an example computer-implemented process that is performable by one or more of the apparatuses, systems, devices, and/or computer program products described herein, for example utilizing one or more of the specially configured components thereof.

The blocks indicate operations of each process. Such operations may be performed in any of a number of ways, including, without limitation, in the order and manner as depicted and described herein. In some embodiments, one or more blocks of any of the processes described herein occur in-between one or more blocks of another process, before one or more blocks of another process, in parallel with one or more blocks of another process, and/or as a sub-process of a second process. Additionally or alternatively, any of the processes in various embodiments include some or all operational steps described and/or depicted, including one or more optional blocks in some embodiments. With regard to the flowcharts illustrated herein, one or more of the depicted block(s) in some embodiments is/are optional in some, or all, embodiments of the disclosure. Optional blocks are depicted with broken (or “dashed”) lines. Similarly, it should be appreciated that one or more of the operations of each flowchart may be combinable, replaceable, and/or otherwise altered as described herein.

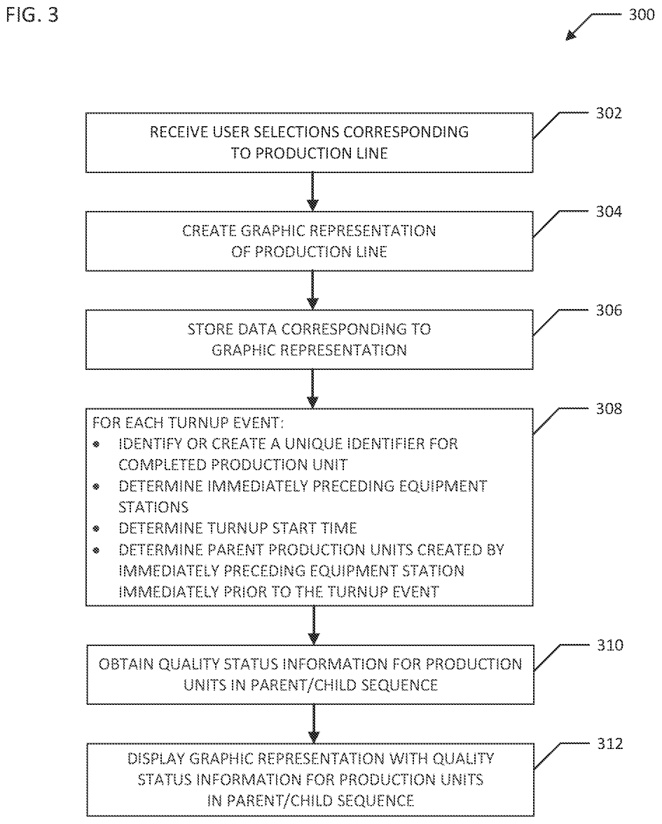

FIG. 3 illustrates a flowchart including example operations of an example process for production and quality tracking. Specifically, FIG. 3 illustrates an example computer-implemented process 300. In some embodiments, the process 300 is embodied by computer program code stored on a non-transitory computer-readable storage medium of a computer program product configured for execution to perform the process as depicted and described. Alternatively or additionally, in some embodiments, the process 300 is performed by one or more specially configured computing devices, such as the apparatus 200 alone or in communication with one or more other component(s), device(s), system(s), and/or the like. In this regard, in some such embodiments, the apparatus 200 is specially configured by computer-coded instructions (e.g., computer program instructions) stored thereon, for example in the memory 204 and/or another component depicted and/or described herein and/or otherwise accessible to the apparatus 200, for performing the operations as depicted and described. In some embodiments, the apparatus 200 is in communication with one or more external apparatus(es), system(s), device(s), and/or the like, to perform one or more of the operations as depicted and described. For example, the apparatus 200 in some embodiments is in communication with separate physical component(s) of one or more industrial plants, and/or the like. For purposes of simplifying the description, the process 300 is described as performed by and from the perspective of the apparatus 200.

At block 302, a processor (such as, but not limited to, the processor 202 of the apparatus 200 described above in connection with FIG. 2, in conjunction with the input/output circuitry 206) receives a plurality of user selections corresponding to a production line to be monitored. Such a production line comprises a plurality of equipment stations, such as, for example, coating machines, dryers, calendering machines, slitters, etc., arranged in a manner in which production units move from one equipment station to the next equipment station. As such, the user inputs include user selections of equipment stations and links between pairs of equipment stations indicating the flow of production units. In various embodiments, such user selections are dragged and dropped from a toolbox of predetermined equipment stations. In various embodiments, such a toolbox is a graphical user interface (GUI) to enable creating a mock production line in which the equipment/stations are arranged in chronological order of the manufacturing process. In various embodiments, user inputs also define data to be captured each time a turnup event occurs at each of the equipment stations, such as equipment station identifier, a unique identifier for the completed production unit, one or more production parameters, and/or a turnup end time.

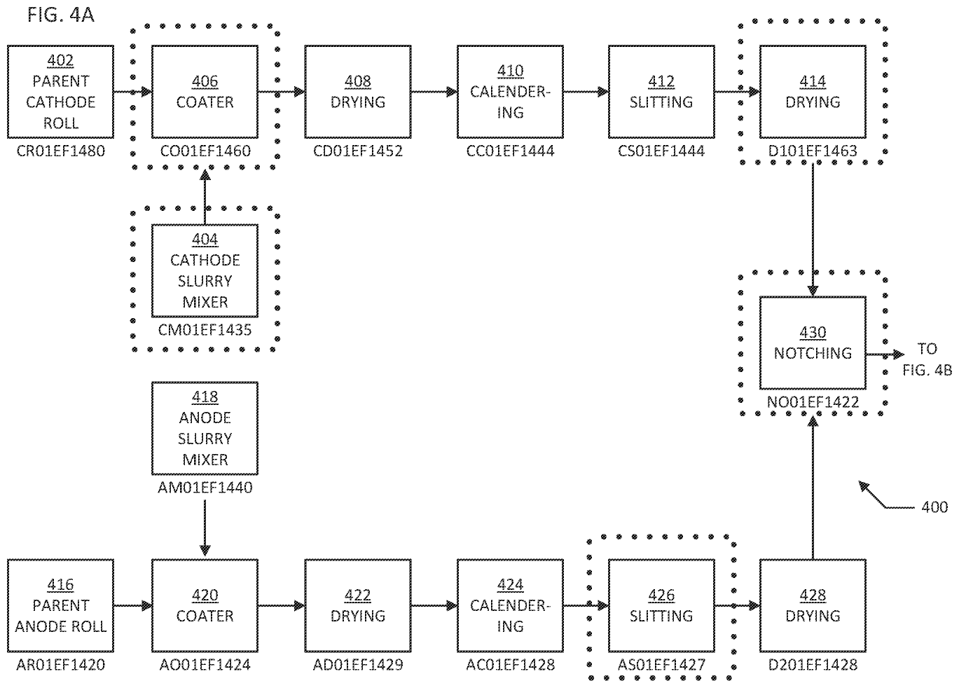

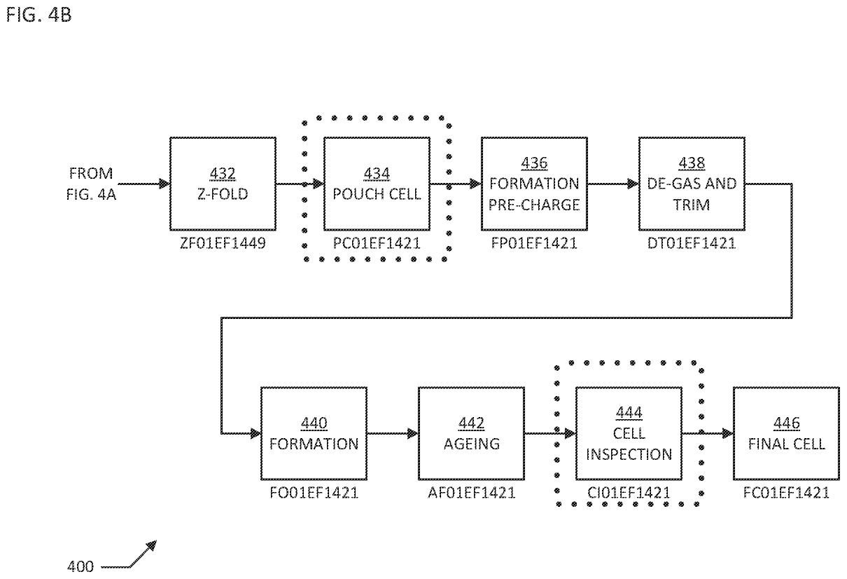

At block 304, a processor (such as, but not limited to, the processor 202 of the apparatus 200 described above in connection with FIG. 2) creates a graphic representation of the production line based on the user selections. An example of such a graphic representation is illustrated in FIGS. 4A and 4B. As seen in FIGS. 4A and 4B, the example graphic representation 400 of a LIB production line comprises a plurality of equipment stations 402-446, such as coaters 406, 420, dryers 408, 422, calendering machines 410, 424, calendering machines 410, 424, and slitters 412, 426. An icon (which may simply be a block as shown in FIGS. 4A and 4B) is illustrated for each equipment station, with arrows indicating the flow of production units from equipment station to equipment station.

Returning to FIG. 3, at block 306, a processor (such as, but not limited to, the processor 202 of the apparatus 200 described above in connection with FIG. 2, in conjunction with the data output circuitry 214) stores the data related to the user selections and the graphical representation, such as in the one or more databases 150.

At block 308, when a turnup event happens at one of the equipment stations, a processor (such as, but not limited to, the processor 202 of the apparatus 200 described above in connection with FIG. 2, in conjunction with the data intake circuitry 212) receives a signal (which may be termed a turnup signal) from the corresponding equipment station. For each turnup event, the processor receives the unique identifier that has been assigned to the production unit by the equipment station. Alternatively, if the equipment station does not assign such a unique identifier to the production unit, the processor will create a unique identifier for the completed production unit. For example, FIG. 4A illustrates the coater 406 having produced a production unit with a unique identifier of CO01EF1460.

Further, for each turnup event, the processor determines the immediately preceding equipment station(s). For example, if a turnup event occurs at the coater 406 of FIG. 4A, the processor will determine that the parent cathode roll 402 and the cathode slurry mixer 404 are the immediately preceding equipment stations. This is determined from the received user selections of the equipment stations and the connections therebetween. Further, for each turnup event, the processor determines the turnup start time. As described above, the turnup start time is calculated based on the turnup end time and a predetermined process time for that specific equipment station. Further, for each turnup event, the processor determines the parent production unit(s) created by the immediately preceding equipment station(s) immediately prior to the turnup event. The parent production unit is the production unit created by the immediately preceding equipment station that was further processed by the equipment station at which the turnup event occurred. In the example illustrated in FIGS. 4A and 4B, if a turnup event occurs at the coater 406, the processor will determine that the parent production unit produced by the parent cathode roll 402 has a unique identifier of CR01EF1480 and that the parent production unit produced by the cathode slurry mixer 404 has a unique identifier of CM01EF1435. In various alternative embodiments, it is also possible that the execution system provides the identity of the parent production unit directly, rather than being determined from turnup start time, etc., as described above.

Returning to FIG. 3, at block 310, a processor (such as, but not limited to, the processor 202 of the apparatus 200 described above in connection with FIG. 2, in conjunction with the data intake circuitry 212) obtains quality status information for the production units in a parent/child sequence. As described above, the production units that are passed from equipment station to equipment station and the final production unit may together be termed a parent/child sequence or a genealogy. In the example graphic representation 400 of FIGS. 4A and 4B, the parent/child sequence includes all of the production units identified by the unique identifiers beneath each equipment station block. That is, FIGS. 4A and 4B illustrate each of the production units that were processed over time by equipment stations 402-446 to produce the final production unit (FC01EF1421) that leaves equipment station 446.

The processor obtains quality status information for each of the production units in the parent/child sequence (if available). In some embodiments, quality status information may not be available for all equipment stations. As described above, such quality status information may be obtained from a variety of different sources, including but not limited to nuclear scanners, imaging systems, and laboratory reports. Such quality status information may include an indication that the quality was not within predetermined tolerances, such as a coating that is too thick or not thick enough. Such quality status information may include an indication that the quality was unacceptable and the production unit should not be used or should be re-worked, and/or it may include an indication that the quality was outside of optimum tolerances but is still acceptable.

Returning to FIG. 3, at block 312, a processor (such as, but not limited to, the processor 202 of the apparatus 200 described above in connection with FIG. 2, in conjunction with the input/output circuitry 206) displays the graphic representation with quality status information (if available) for the production units in the parent/child sequence. The quality status information may be displayed in any suitable manner. For example, the icon may be displayed in a different color if there is relevant quality status information. For example, the icon may be displayed in red if the quality status information indicates that the quality of a production unit was determined to be unacceptable, and the icon may be displayed in yellow if the quality status information indicates that the quality of a production was determined to be outside of optimum tolerances but still acceptable. In the example graphic representation 400 of FIGS. 4A and 4B, such a quality status indication is illustrated by the dotted squares around blocks 404, 406, 414, 426, 430, 434, and 444.

In various embodiments, the quality status information for each equipment station in a parent/child sequence is used to identify one or more root causes of unacceptable quality status of a production unit based on unacceptable quality status of a prior different production unit in the parent/child sequence. That is, when attempting to determine the cause of a quality problem at one equipment station, the genealogical quality status information displayed in the graphic display enables a user to readily identify quality problems at one or more preceding equipment stations that may have contributed to the quality problem being investigated.

### CONCLUSION

Although an example processing system has been described above, implementations of the subject matter and the functional operations described herein can be implemented in other types of digital electronic circuitry, or in computer software, firmware, or hardware, including the structures disclosed in this specification and their structural equivalents, or in combinations of one or more of them.

Embodiments of the subject matter and the operations described herein can be implemented in digital electronic circuitry, or in computer software, firmware, or hardware, including the structures disclosed in this specification and their structural equivalents, or in combinations of one or more of them. Embodiments of the subject matter described herein can be implemented as one or more computer programs, i.e., one or more modules of computer program instructions, encoded on computer storage medium for execution by, or to control the operation of, information/data processing apparatus. Alternatively, or in addition, the program instructions can be encoded on an artificially generated propagated signal, e.g., a machine-generated electrical, optical, or electromagnetic signal, which is generated to encode information/data for transmission to suitable receiver apparatus for execution by an information/data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The operations described herein can be implemented as operations performed by an information/data processing apparatus on information/data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a repository management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or information/data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described herein can be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read-only memory or a random access memory or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, e.g., magnetic, magneto-optical disks, or optical disks. However, a computer need not have such devices. Devices suitable for storing computer program instructions and information/data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described herein can be implemented on a computer having a display device, e.g., a CRT (cathode ray tube) or LCD (liquid crystal display) monitor, for displaying information/data to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described herein can be implemented in a computing system that includes a back-end component, e.g., as an information/data server, or that includes a middleware component, e.g., an application server, or that includes a front-end component, e.g., a client computer having a graphical user interface or a web browser through which a user can interact with an implementation of the subject matter described herein, or any combination of one or more such back-end, middleware, or front-end components. The components of the system can be interconnected by any form or medium of digital information/data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits information/data (e.g., an HTML page) to a client device (e.g., for purposes of displaying information/data to and receiving user input from a user interacting with the client device). Information/data generated at the client device (e.g., a result of the user interaction) can be received from the client device at the server.

While this specification contains many specific implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method for production tracking, the method comprising:
receiving a plurality of user selections corresponding to (i) a plurality of equipment stations of a production line, (ii) links from each equipment station to one or more preceding equipment stations and/or one or more succeeding equipment stations, and (iii) data to be captured each time a turnup event indicating completion of a production unit occurs at each of one or more of the equipment stations;
creating a graphic representation of the production line corresponding to the plurality of user selections;
storing data corresponding to the graphic representation in one or more servers or one or more cloud computing devices;
each time a turnup event occurs at one of the plurality of equipment stations, determining (i) any immediately preceding equipment stations to the one of the equipment station at which the turnup event occurred, (ii) a turnup start time, and (iii) one or more parent production units created by the immediately preceding equipment station immediately prior to the turnup event;
obtaining quality status information for each of a plurality of production units in a parent/child sequence; and
displaying the graphic representation of the production line with the quality status information for each of the plurality of production units in the parent/child sequence.

2. The method of claim 1, wherein the turnup start time is determined based on a turnup end time and a predetermined process time.

3. The method of claim 1, further comprising identifying one or more root causes of an unacceptable quality status of a production unit based on an unacceptable quality status of a prior different production unit in the parent/child sequence.

4. The method of claim 1, further comprising, each time a turnup event occurs, identifying or creating a unique identifier for the completed production unit.

5. The method of claim 1, wherein the data to be captured each time a turnup event occurs includes a station identifier, a unique identifier for the completed production unit, and one or more production parameters.

6. The method of claim 5, wherein the one or more production parameters include width, length, weight, speed, diameter, and a turnup end time.

7. The method of claim 1, wherein the user selections of equipment stations and links are dragged and dropped from a predetermined toolbox of selections.

8. An apparatus for production tracking, the apparatus comprising at least one processor and at least one non-transitory memory comprising program code, wherein the at least one non-transitory memory and the program code are configured to, with the at least one processor, cause the apparatus to at least:
receive a plurality of user selections corresponding to (i) a plurality of equipment stations of a production line, (ii) links from each equipment station to one or more preceding equipment stations and/or one or more succeeding equipment stations, and (iii) data to be captured each time a turnup event indicating completion of a production unit occurs at each of one or more of the equipment stations;
create a graphic representation of the production line corresponding to the plurality of user selections;
store data corresponding to the graphic representation in one or more servers or one or more cloud computing devices;
each time a turnup event occurs at one of the plurality of equipment stations, determine (i) any immediately preceding equipment stations to the one of the equipment station at which the turnup event occurred, (ii) a turnup start time, and (iii) one or more parent production units created by the immediately preceding equipment station immediately prior to the turnup event;
obtain quality status information for each of a plurality of production units in a parent/child sequence; and
display the graphic representation of the production line with the quality status information for each of the plurality of production units in the parent/child sequence.

9. The apparatus of claim 8, wherein the turnup start time is determined based on a turnup end time and a predetermined process time.

10. The apparatus of claim 8, wherein the at least one non-transitory memory and the program code are further configured to, with the at least one processor, cause the apparatus to at least:
identify one or more root causes of an unacceptable quality status of a production unit based on an unacceptable quality status of a prior different production unit in the parent/child sequence.

11. The apparatus of claim 8, wherein the at least one non-transitory memory and the program code are further configured to, with the at least one processor, cause the apparatus to at least:
each time a turnup event occurs, identify or creating a unique identifier for the completed production unit.

12. The apparatus of claim 8, wherein the data to be captured each time a turnup event occurs includes a station identifier, a unique identifier for the completed production unit, and one or more production parameters.

13. The apparatus of claim 12, wherein the one or more production parameters include width, length, weight, speed, diameter, and a turnup end time.

14. The apparatus of claim 8, wherein the user selections of equipment stations and links are dragged and dropped from a predetermined toolbox of selections.

15. A computer program product for production tracking, the computer program product comprising at least one non-transitory computer-readable storage medium having computer-readable program code portions stored therein, the computer-readable program code portions comprising an executable portion configured to:
receive a plurality of user selections corresponding to (i) a plurality of equipment stations of a production line, (ii) links from each equipment station to one or more preceding equipment stations and/or one or more succeeding equipment stations, and (iii) data to be captured each time a turnup event indicating completion of a production unit occurs at each of one or more of the equipment stations;
create a graphic representation of the production line corresponding to the plurality of user selections;
store data corresponding to the graphic representation in one or more servers or one or more cloud computing devices;
each time a turnup event occurs at one of the plurality of equipment stations, determine (i) any immediately preceding equipment stations to the one of the equipment station at which the turnup event occurred, (ii) a turnup start time, and (iii) one or more parent production units created by the immediately preceding equipment station immediately prior to the turnup event;
obtain quality status information for each of a plurality of production units in a parent/child sequence; and
display the graphic representation of the production line with the quality status information for each of the plurality of production units in the parent/child sequence.

16. The computer program product of claim 15, wherein the turnup start time is determined based on a turnup end time and a predetermined process time.

17. The computer program product of claim 15, wherein the computer-readable program code portions comprise an executable portion configured to:
identify one or more root causes of an unacceptable quality status of a production unit based on an unacceptable quality status of a prior different production unit in the parent/child sequence.

18. The computer program product of claim 15, wherein the computer-readable program code portions comprise an executable portion configured to:
each time a turnup event occurs, identify or create a unique identifier for the completed production unit.

19. The computer program product of claim 15, wherein the data to be captured each time a turnup event occurs includes a station identifier, a unique identifier for the completed production unit, and one or more production parameters.

20. The computer program product of claim 15, wherein the user selections of equipment stations and links are dragged and dropped from a predetermined toolbox of selections.
